(19) United States
(12) Patent Application Publication
(10) Pub. No.: US 2004/0258280 A1
(43) Pub. Date: Dec. 23, 2004

(54) Optical document authentication system

(75) Inventors: Trevor Merry, Ottawa (CA); Ileana Buzuloiu, Ottawa (CA); Jack Sinclair, Ottawa (CA)

Correspondence Address: CASSAN MACLEAN, 80 ABERDEEN STREET, SUITE 401, OTTAWA, ON, K1S 5R5, CA

(73) Assignee: Canadian Bank Note Company, Ltd.

(21) Appl. No.: 10/602,040

(22) Filed: Jun. 23, 2003

(51) Int. Cl. G06K 9/00

(52) U.S. Cl. 382/115

(57) ABSTRACT

Methods, articles, and systems related to the verification and association of an identity of a specific person. A constellation or grouping of marks derived from physical characteristics of the specific person is printed on an article of manufacture. The constellation or groups of marks is derived from the person's characteristic facial features, fingerprint or eye. The constellation or grouping of marks may be overlaid onto the persons photograph on an identity card. Multiple groupings, with each grouping being derived from a different characteristic, may be overlaid over one another with different wavelengths of light being required to illuminate specific groupings. To verify the person's identity, a scan of the person's relevant characteristics, such as his fingerprint or an iris scan, is performed and the results are compared to the relevant constellation or grouping of marks printed on the article of manufacture. A match indicates that the person and the article of manufacture are associated with another and that they are both probably legitimate. The constellation or group of marks may be encrypted to hide the true identifying characteristics of the person.

### FIELD OF THE INVENTION

The present invention relates generally to document identification systems. More specifically, the present invention is particularly applicable but is not limited to systems, methods, and articles of manufacture related to marking documents with unique identifying indicia, such as biometric based marks, for identification purposes.

### BACKGROUND TO THE INVENTION

The increased attention to security and security measures of the past few years has led to the development of newer and more secure identification systems. Security features which prevent forgeries and “spoofing” of security systems can now be found on everything from paper money to personal checks and identification cards. Government based initiatives to increase security at, among other places, airports and government buildings have been mirrored by moves in private industry to improve their own security.

Historically, many types of identification documents have included a portrait of the bearer, either adhered to, or imprinted on them. To authenticate the bearer, the portrait on the document is visually compared to the bearer's face by an inspector who makes a judgment whether there is a match between the two. A more secure variation of the identification document also has an image of a fingerprint on the document. While this provides a useful forensic confirmation of identity, it is difficult to make an instantaneous visual determination of a match between the fingerprint on the document and the bearer's fingerprint without considerable experience. More recently, it has become desirable to allow a number of different transactions to be accomplished solely on the basis of a personal identification document linked to a unique physical characteristic without the intervention of a human inspector to determine if a match exists. This cannot be accomplished by traditional documents and examination methods alone and other means are usually required to rapidly and securely effect positive identification in a manner that may not require access to an external database.

To address the above issues, smart cards containing embedded memory chips or magnetic or optical stripes are widely used. In these devices, the biometric-based identification data can be stored in the form of a “template”, an encoded digital representation of biometric information. The cards and the equipment to read them are relatively expensive compared to a traditional identification document. Moreover, they are not universally applicable as there is still the need in many cases to retain the option of a traditional visual document system while adding the benefits of machine-based biometric authentication. Passports and visas are examples of such paper-based documents that would benefit from a confluence between the traditional visual document system and machine-based biometric authentication.

An alternative to the smart cards but which also addresses the above issues is the use of a two-dimensional barcode. In this technology, with data compression techniques, the biometric template is printed on the document in the form of an encoded block of light and dark elements. These elements may be read and decoded by an optical reader. While this alternative is, in many instances, cheaper to produce and use than a smart card, the physical space required by the barcode is relatively large, thereby leaving less room for visual data or alternate biometrics on an identification document.

Based on the above, there is therefore a need for an alternative that reduces the data which needs to be encoded, that is cheap, and that does not require extra room on the identification card.

### SUMMARY OF THE INVENTION

The present invention provides methods, articles, and systems related to the verification and association of an identity of a specific person. A constellation or grouping of marks derived from physical characteristics of the specific person is printed on an article of manufacture. The constellation or group of marks is derived by biometric systems that can identify unique points of interest (such as minutiae points in a fingerprint) from the person's characteristic facial features, fingerprint or eye. The constellation or grouping of marks may be overlaid onto the person's photograph on an identity card. Multiple groupings, with each grouping being derived from a different characteristic, may be overlaid over one another with different wavelengths of light being used to illuminate specific groupings. To verify an identity, a scan of the person's relevant biometrics, such as his fingerprint or an iris scan, is performed and the results are compared to the relevant constellation or grouping of marks printed on the article of manufacture. A match indicates that the person and the article of manufacture are legitimately associated with each other. The constellation or grouping of marks may be encrypted to hide the true identifying characteristics of the person. The use of the constellation avoids the problems associated with the storage of large amounts of data by maintaining a graphic representation of the identifying information.

In a first aspect the present invention provides an article of manufacture having applied thereto a group of marks arranged for associating a specific person with said article, the group of marks collectively being useful for identifying said person and said marks being collectively derived from physical characteristics of said person.

In a second aspect the present invention provides a constellation of marks applied to a predefined area of an article of manufacture a positioning of each mark of said constellation of marks in said area being derived from a physical characteristic of a specific person such that a collective arrangement of said constellation of marks is unique to said person, said constellation of marks being useful for associating said article to said person.

In a third aspect the present invention provides a method of matching an article of manufacture with a specific person, the method comprising:

a) detecting a graphical constellation of marks applied to said article, said constellation being applied to a specific area of said article;

b) processing said constellation of marks to result in a graphical representation useful for comparison with a data set associated with said person;

c) acquiring said data set associated with said person;

d) comparing said data set and said representation to determine a likelihood of a match between said data set and said representation; and

e) if a likelihood exceeds a predetermined threshold, associating said article with said person.

### BRIEF DESCRIPTION OF THE DRAWINGS

A better understanding of the invention will be obtained by considering the detailed description below, with reference to the following drawings in which:

FIG. 1 is a diagram of a fingerprint with relevant minutiae highlighted;

FIG. 2 is a constellation of marks derived from the minutiae indicated in FIG. 1;

FIG. 3 is a diagram of a human face with the relevant identifying points highlighted;

FIG. 4 is a constellation of marks derived from the identifying points illustrated in FIG. 3; and

FIG. 5 is an illustration of an identification card on which the invention may be practiced.

### DETAILED DESCRIPTION

As is well-known in the art of identification systems, fingerprints, iris or retina scans, facial recognition and other biometric based identified systems are based on a correlation between points or marks derived from a known sample and an unknown sample. For fingerprints, the specific characteristics of the ridges and valleys found on each finger (the so-called minutiae) are used to differentiate one print from another. Specifically, the ending of the lines, the split of the lines into forks, or the formation of islands, and other discernible characteristics, and their pattern, are used to identify and associate a person with his or her fingerprint. A map of these minutiae can be made with each point on the map corresponding to a specific minutiae on the print.

Eye-based biometric systems (such as retinal and/or iris scan based systems) that identify unique points of interest (such as bifurcations and end-points) can also be used to generate a constellation or group/array of marks. One iris scan system operates by comparing the pattern of lines in a human iris. The pattern of lines in an iris can also be reduced to a map similar to that for fingerprints by encoding the pattern in a well-known manner.

In a similar way to eye-based biometric systems, facial recognition technologies that identify unique points of interest on a human face can also be used to generate a constellation or group/array of marks. Such techniques may use a variety of mathematical and/or algorithmic techniques to calculate and/or map these unique points of interest. As an example, some facial scans work differently from fingerprints or iris scans but these can also be reduced into a map made up of multiple marks. Some facial recognition systems operate on the relative spacing and pattern between specific points on the human face. As an example, three specific points may denote a person's eye—one point for each of the corners and one point for the approximate middle of the eye. One way to identify a person, given these points would be to measure the relative spacing between these three points and the spacing between any of the three points and other points which denote other facial features such as the mouth or the nose. These same points which denote the different facial features may be converted into a point map, with each point on the face corresponding to a point on the point map.

Other point maps derived from a person's unique physical characteristics may also be constructed. Other technologies that may generate a constellation of marks from unique points of interest include hand-scan technologies, DNA analysis, and voice recognition. Any process capable of generating a unique set of points from physical dimensions or physical characteristics of an individual (or of an image) may be used by the present invention. Fingerprint matching technology, iris and retina scan technology, and facial recognition technology, are provided as three types of identification systems which may be used with the present invention. Specifically, the point maps derived from these three identification systems can be easily used as a constellation or group of marks to be printed on an article of manufacture such as an identity card.

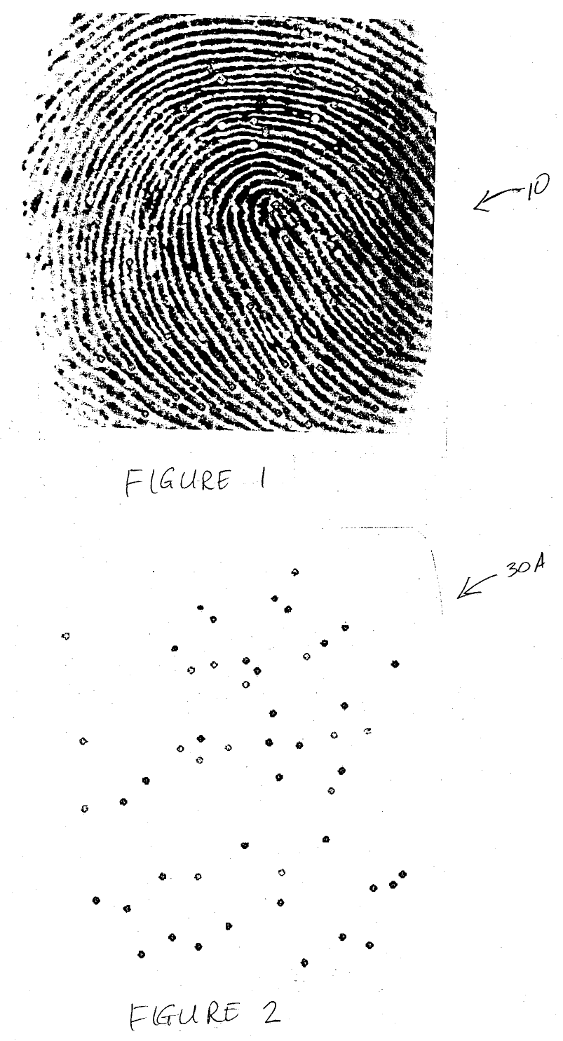

Referring to FIG. 1, a fingerprint 10 has specific marks (the minutiae) that distinguishes this specific fingerprint from others. As can be seen, the marks denote either intersection points between the ridges (light spots) or end points (dark spots) for the ridges. Referring to FIG. 2, these marks can be isolated from the fingerprint as a constellation or group of marks 30A. By itself, the constellation 30A appears to be an unrelated collection of marks. However, when a subject fingerprint and the constellation 30A are compared, a level of confidence about their similarity is generated and this can be used to determine if the constellation and the subject fingerprint match each other. It should be noted that different types of distinguishing marks on the same body part may be used to extract different constellations. As an example the intersection points between ridges in a fingerprint could be used to produce one constellation while the end points for the ridges could be used to produce another separate constellation.

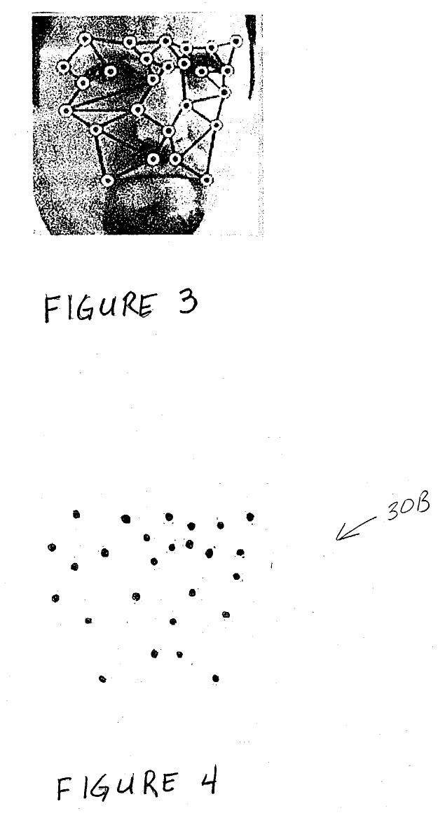

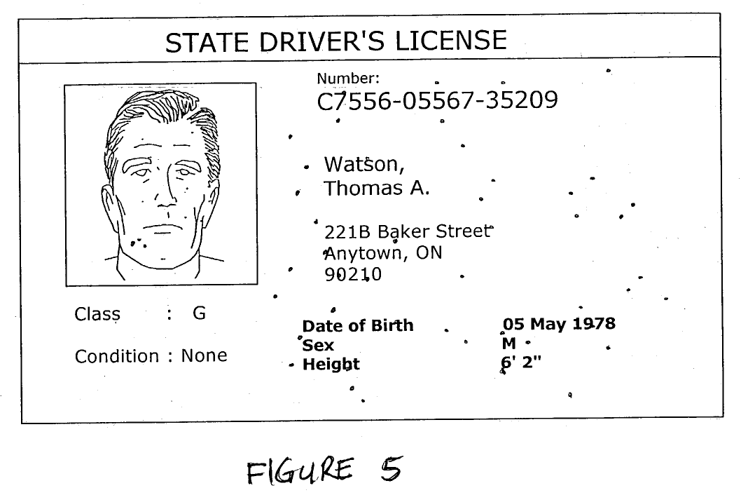

The same process can be applied to an iris, retina, or facial scan. Referring to FIG. 3, a male face with the relevant facial points is illustrated. Normally, the relative positioning of these facial points will uniquely identify a specific face. However, if these facial points are isolated from the face upon which they are based (see FIG. 4), what results is a constellation or group of marks 30B. Again, this merely appears to be an unrelated group of marks. However, when compared with a scan of a human face, the marks either correlate with a facial feature (such as corners of a mouth or the eyeballs), or they do not. If they do not match, then the face on the scan is not the face from which the constellation 30B is derived.

Both the constellations 30A and 30B can be printed on any article of manufacture which is to be used for identification purposes. Ideally, these constellations can be printed on documents such as, for example, identification cards. The person carrying the identification card can be verified as the person identified on the card. Instead of printing the person's fingerprint on the card, the constellation 30A can be printed on a specific area of the card and, when required, the constellation 30A can be scanned and extracted for comparison with a sample fingerprint obtained from the carrier of the card. The comparison can be done automatically by a computing device specifically so tasked. For the facial constellation 30B, the constellation 30B may also be printed on an area of the identity card separate from the area where the constellation 30A is printed. The constellation 30B can then be retrieved/scanned for eventual comparison with the facial features of the cardholder.

In one embodiment, either constellation may be printed on the photograph section of the identity card. As FIG. 5 shows, the photograph section 40 of the identity card is usually the most prominent area of the card. A constellation may be overlaid over the photograph or over the whole card. To prevent the quality of the photograph from being compromised by the constellation, well-known special inks which only appear under different wavelengths of light may be used. As an example, if ultra-violet (UV) sensitive ink is used, the constellation of marks overlaid on the photograph will not be visible unless UV light is used to illuminate the picture. The constellation which will then appear can be scanned into a computer and compared with a “fresh” biometric sample obtained from the cardholder. This “fresh” biometric sample can be obtained from the cardholder using well-known means such as scanning his/her fingerprint, face, retina, iris, or other body part. As an example of a direct overlay, the constellation 30A is overlaid over the identity card in FIG. 5. The marks in the constellation do not detract from the visual identification capability of the portrait image and are generally unobtrusive to the unaided human eye. In the example, the constellation merely appears as a random series of dots on the card.

As a variant to the above, multiple different constellations, each being derived from a different body part can be printed on the same area of the document. To differentiate between constellations, each constellation can be printed using ink that is sensitive to a different wavelength of light. As an example, a constellation derived from a fingerprint can be printed on the photograph on an identity card using UV sensitive ink. Another constellation, this time from an iris scan, can be printed on the same photograph using IR (infra red) sensitive ink. Thus, to see (and scan) the fingerprint constellation, UV light is used to illuminate the photograph. To see (and scan) the iris-derived constellation, IR light is used to illuminate the photograph.

It should be noted that, even though the above examples detail printing the constellation(s) on a photograph on an identity card or on an identification document, other areas of the identity document, indeed any area of any document, can be used. Areas of an identity card which are not normally associated with having identity features, such as perhaps a back of the card or the area containing the name and other relevant information regarding the cardholder, can be used. The light wavelength specific ink used to print the constellations on the card would render the constellations invisible or less noticeable when printed on the card. Furthermore, articles of manufacture other than an identity card or a pass can incorporate the above discussed constellations. As an example, memoranda or other documents can have printed on them (using either visible or light dependent ink) the constellation derived from physical characteristics of the author. This will ensure that the document is clearly associated with a specific individual—the person who has physical characteristics from which the printed constellation is derived.

As noted above, multiple constellations can be overlaid over one another in the same area. While the use of light specific ink would simplify differentiating one constellation from another, other methods for differentiating them may also be used. As an example, each different constellation may utilize a mark or shape different from that used by other constellations. As an example, a constellation derived from an iris scan system may use different marks and shapes than constellation derived from a facial recognition system. Both of these constellation would use marks and shapes different from that used by a constellation derived from a fingerprint system. Alternatively, at least two constellations, each derived from different biometrics (such as a fingerprint and an iris scan), may be combined to form a single constellation. This single constellation would be used to compare with a combined data set derived from two “fresh” biometric scans of the person. The results of an iris scan and a fingerprint scan would be combined to form a data set to be compared with the single resulting constellation.

It should be noted that, even though the above contemplates printing multiple constellations in a single area, it is also possible that a single document may have multiple constellations, each being printed in a different area. As an example, a passport may have a fingerprint constellation overlaid over the passport photograph while having a facial scan constellation printed elsewhere in the document. Similarly, an identification card can have an iris scan constellation on one side while also having a fingerprint scan constellation printed on the other side. Documents not traditionally associated with identification purposes (such as the memoranda mentioned above) may have one constellation, albeit shrunk to an appropriate size, on one corner and another constellation on another corner.

While the above notes printing the constellation of marks on the document, other equally viable alternatives are available. The constellation of marks may be embossed on the document or it may be engraved on the document. Of course, the constellation may be embossed, printed, or engraved anywhere on the document. The document may also have multiple constellations applied to it with more than one method of application being present on a single document. As an example, a constellation of marks derived from a fingerprint may be printed on the photograph on a driver's license while a constellation derived from an iris scan may be embossed on the reverse side of the same document. Any method of applying or marking a constellation on to a document, whether three dimensional (such as embossing or engraving) or two dimensional (such as printing) is suitable and is covered by the present invention. For such a method, the substrate to be marked, either the document itself or a photograph or other substrate ultimately to be incorporated into the document itself, will, after marking, bear the constellation. Ideally, such a marking or application will produce marks unobtrusive to an unaided human eye so as not to obfuscate any other data on the document.

To prevent unauthorized entities from accessing and misusing the data inherent in the constellations, a form of encryption, such as a visual transformation of the constellation, may be used. To visually transform a constellation so as to “hide” the true constellation, instead of directly printing the constellation directly derived from the person being associated with the document, the marks on the constellation are moved or their positions are distorted in a predefined manner and this “distorted” constellation is what is printed on the document. The “distortion” or movement of the constellation's marks may be a simple translation using a simple algebraic or mathematical formula. If the marks on the constellation are seen as points on a two-dimensional Cartesian co-ordinate system, each mark can be moved or repositioned according to a first algebraic formula. To obtain the original position of the mark, a second similar algebraic formula that is the mathematical inverse of the first formula is applied to the moved marks. This second formula negates the movement effect of the first formula and the original position of the mark is restored. As long as both formulae are kept secret, the true positions of the marks on constellation cannot be easily found. As an added security feature, the algebraic or mathematical formulae used to visually transform the constellation and to negate this visual transformation may be provided with configurable (either user entered or automatically provided) coefficients or values. A unique configurable value provided to the formulae would visually transform the constellation in one manner while another unique value provided to the formulae would visually transform the constellation in another manner. It should be noted that the above is provided as an example of one type of hiding or “encrypting” the true constellation. Other techniques which may visually transform the constellations and thereby “hide” the true positioning of the marks, including some well-known techniques, may be employed.

To properly verify a document marked with constellations and the person who presents such a document, the following process is illustrates one manner in which the document may be verified.

First, the document is obtained from the person to whom the document is to be associated with. Thus may be done at a checkpoint (for identity cards and other identity documents), or at any verification center (e.g. at an office which issues firearms licenses, driver's licenses and the like).

Second, the document is scanned for any constellations printed on it. Depending on the implementation and on the techniques used to print the constellation or constellations, the scanning may take multiple steps. If light wavelength sensitive ink is used to print the constellation, then the area containing the constellation must first be illuminated with light having the relevant wavelength. Once illuminated, the constellation can be detected and scanned into a data processing machine such as a properly configured computer with the relevant software. This scanning can be accomplished using well-known techniques. Usually, scanning an image into a computer involves capturing a digital image representation of the image being scanned in the computer. The digital image representation can then be analysed, processed, or compared with another image. It should be noted that the scanning step may need to be performed multiple times with each constellation on the document requiring at least one iteration of the scanning step.

Once the constellation has been scanned into the machine, the digital image may need to be processed as a third step. If encryption has been used, then the information in the digital image (i.e. the positioning of the marks in the constellation) will need to be decrypted. If the encryption scheme used is that outlined above, the decryption is effected by mapping the marks on the digital image onto a Cartesian coordinate system and then applying the known mathematical inverse of the encrypting formula to the marks. As noted above, this will result in the original positioning of the marks in the constellation. Other processing which may be implementation dependent, may be required.

It should be noted that mapping the marks in the digital image onto a coordinate system may simplify comparing the mapping to either a “fresh” biometric sample or one stored in a database. Furthermore, a grid reference system such as the Cartesian coordinate system used may, again, simplify the comparison step.

It should further be noted that the scanning and processing steps are to be executed separately for each constellation. Ideally, each digital image/constellation retrieved from the document is kept separate from other digital image/constellation from the same document to prevent confusion.

The fourth step in the process would be the obtaining of a “fresh” biometric sample from the person seeking to be associated with the document containing the constellation or constellations. Depending on which body part or parts the constellations are derived from, this step may involve one or more of the following: a facial scan, a fingerprint scan, an iris scan, or a scan of any relevant body part. The scanning of the relevant body part or parts may be accomplished by using well known techniques. Once this scanning is done, the machine can then automatically extract and map the relevant features of the body part. The resulting map can then be compared with the constellation found or extracted from the document. Depending on the level or extent of correlation between the two, a match can then be determined.

As a simpler alternative, the scan of the body part can be overlaid over the constellation derived from or printed on the document. A human interpreter can then determine by eye whether there are features on the body part scan which correspond to and are in approximately in the same location as the marks in the constellation. For a better indication of the correlation of the body parts scan and the constellation, the constellation can be placed on the same coordinate system as the body part scan. Then, either through a machine or the human interpreter, a comparison can be made. This step would be taken only after a single relevant constellation is extracted and isolated from the document to prevent multiple constellations from interfering with each other's data.

The above could be accomplished automatically by means of image subtraction. The scan of the constellation from the document could be digitally subtracted from a constellation derived form a “fresh” biometric scan. Any discrepancies will therefore be easily identifiable. Of course, to take into account possible errors or mismatches due to the “fresh” scan, minute physical changes in the body part being scanned, etc., a match threshold may be established. A scoring system, dependent on a likelihood of a match between the two constellations (one from the document and another from a “fresh” scan or a database) would determine a match. If the score meets or exceeds the threshold, then a match can be declared. For human interpreters of the match, the two resulting constellations could, again, be compared by overlaying one constellation over the other to visually indicate a level or likelihood of a match.

It should be noted that a machine comparison between the body part scan and the constellation has to consider the fact that although the constellation is invariant, the personal physical characteristics may change somewhat from time to time. Therefore, there has to be a reasonable degree of freedom within the system to conclude that a match has indeed been made even though there is not an exact correlation between the two.

Depending upon the implementation and the requirements of the system, instead of a “fresh” biometric sample from the person to be associated with the document, a data set representing the biometric sample can be retrieved from a database. This would be useful if, as an example, a document having a constellation printed on it was received but it was not known who the author was. The database retrieved data set can them be used to compare with the constellation on the document. One method of accomplishing this is to use the constellation from the document to create a template. The database retrieved data set is also used to create another template (or the data set could be stored as a template). The two templates, one from the database and one from the constellation, are then compared for a match.

Using the above invention, if a match is made between the biometric sample (or data set) and the constellation derived from or printed on the document, the association made between the person and the document can lead to different consequences. It may allow access to restricted areas, establish an identity, or any other functions which the user may be deem necessary.

A person understanding this invention may now conceive of alternative structures and embodiments or variations of the above all of which are intended to fall within the scope of the invention as defined in the claims that follow.

We claim:

1. An article of manufacture having applied thereto a group of marks arranged for associating a specific person with said article, the group of marks collectively being useful for identifying said person and said marks being collectively derived from physical characteristics of said person.

2. An article of manufacture according to claim 1 wherein said group of marks are derived from characteristics of a fingerprint of said person.

3. An article of manufacture according to claim 1 wherein said group of marks are derived from characteristics of an eye of said person.

4. An article of manufacture according to claim 1 wherein said group of marks are derived from characteristics of a face of said person.

5. An article of manufacture according to claim 1 wherein said group of marks are unobtrusive to an unaided human eye.

6. An article of manufacture according to claim 1 wherein said group of marks are detectable by optical means.

7. An article of manufacture according to claim 1 wherein said group of marks are overlaid over a photograph of said person.

8. An article of manufacture according to claim 1 wherein said group of marks comprises at least two sub-groups of marks, each sub-group of marks being derived from a specific group of physical characteristics of said person.

9. An article of manufacture according to claim 8 wherein at least one of said at least two sub-groups of marks is derived from characteristics of a fingerprint of said person.

10. An article of manufacture according to claim 8 wherein at least one of said at least two sub-groups of marks is derived from characteristics of an eye of said person.

11. An article of manufacture according to claim 8 wherein at least one of said at least one of said at least two sub-groups of marks is derived from characteristics of a face of said person.

12. An article of manufacture according to claim 8 wherein each sub-group of marks of said at least two sub-groups of marks is separately detectable by using detection means.

13. An article of manufacture according to claim 12 wherein said detection means comprises different wavelengths of light.

14. An article of manufacture according to claim 12 wherein adjustment of said detection means allows for detection of different sub-groups of marks.

15. An article of manufacture according to claim 8 wherein different sub-groups of marks comprise differently sized indicia.

16. An article of manufacture according to claim 8 wherein different sub-groups of marks comprise differently shaped indicia.

17. An article of manufacture according to claim 1 wherein said group of marks is placed in an area containing other data.

18. An article of manufacture according to claim 1 wherein said group of marks is a result of applying a visual transformation process to a data set derived from said physical characteristics of said person.

19. An article of manufacture according to claim 1 wherein said article has at least one predefined area where said group of marks is printed.

20. An article of manufacture according to claim 19 wherein said predefined area contains data other than said group of marks.

21. An article of manufacture according to claim 1 wherein said group of marks is printed on said article.

22. An article of manufacture according to claim 1 where in said group of marks is embossed on said article.

23. An article of manufacture according to claim 1 wherein said group of marks is engraved on said article.

24. A constellation of marks applied to a predefined area of an article of manufacture a positioning of each mark of said constellation of marks in said area being derived from a physical characteristic of a specific person such that a collective arrangement of said constellation of marks is unique to said person, said constellation of marks being useful for associating said article to said person.

25. A constellation of marks according to claim 24 wherein said physical characteristic is found on a body part of said person.

26. A constellation of marks according to claim 25 wherein said body part is a finger.

27. A constellation of marks according to claim 25 wherein said body part is an eye.

28. A constellation of marks according to claim 25 wherein said body part is a face.

29. A constellation of marks according to claim 24 wherein said specific area contains data other than said constellation of marks.

30. A constellation of marks according to claim 29 wherein said specific area contains a photograph of said person.

31. A constellation of marks according to claim 30 wherein said constellation of marks are overlaid on said photograph.

32. A constellation of marks according to claim 25 wherein said constellation comprises at least two sub-groups of marks, each sub-group of marks corresponding to physical characteristics found on different body parts.

33. A constellation of marks according to claim 32 wherein each sub-group is separately detectable by an adjustment of optical illumination means.

34. A constellation of marks according to claim 33 wherein said adjustment adjusts a wavelength of light being used to detect said sub-groups.

35. A constellation of marks according to claim 24 wherein a position of at least one of said marks is visually transformed such that said position is adjusted.

36. A constellation of marks according to claim 35 wherein said position is adjusted according to a predetermined mathematical formula.

37. A constellation of marks according to claim 35 wherein an original position of said at least one of said marks is recoverable.

38. A method of matching an article of manufacture with a specific person, the method comprising:
a) detecting a graphical constellation of marks applied to said article, said constellation being applied to a specific area of said article;
b) processing said constellation of marks to result in a graphical representation useful for comparison with a data set associated with said person;
c) acquiring said data set associated with said person;
d) comparing said data set and said representation to determine a likelihood of a match between said data set and said representation; and
e) if a likelihood exceeds a predetermined threshold, associating said article with said person.

39. A method according to claim 38 wherein step a) includes illuminating said specific area with light having a specified wavelength.

40. A method according to claim 38 wherein step b) includes optically scanning said constellation of marks detected in step a).

41. A method according to claim 38 wherein step b) includes applying a visual transformation process to said constellation of marks to recover original positions of said constellation of marks.

42. A method according to claim 38 wherein step b) includes mapping said constellation on to a predefined grid.

43. A method according to claim 38 wherein step c) includes accessing a database and retrieving said data set.

44. A method according to claim 38 wherein step c) includes directly acquiring said data set from said person by way of a biometric acquisition system.

45. A method according to claim 38 wherein said constellation of marks comprises a constellation of marks applied to a predefined area of an article of manufacture, a positioning of each mark of said constellation of marks in said area being derived from a physical characteristic of a specific person such that a collective arrangement of said constellation of marks is unique to said person, said constellation of marks being useful for associating said article to said person.

46. A method according to claim 38 wherein said article comprises an article of manufacture having applied thereto said constellation of marks arranged for associating a specific person with said article, the constellation of marks collectively being useful for identifying said marks being collectively derived from physical characteristics of said person.

47. An article of manufacture according to claim 1 wherein said group of marks is applied to said article by three dimensional marking means.
